(19) United States
(12) Patent Application Publication
(10) Pub. No.: US 2004/0248678 A1
(43) Pub. Date: Dec. 9, 2004

(54) Continuously variable transmission with axially movable pulley hub units

(76) Inventors: Hendrikus Jan Kapaan, DM Nieuwegein (NL); Cornelius Petrus Antonius Vissers, Den Dungen (NL); Jacobus Zwarts, Nieuwegein (NL); Bernardus Gerardus Van Leeuwen, Nieuwegein (NL); Paul Bernard Meaney, Utrecht (NL)

Correspondence Address: OLIFF & BERRIDGE, PLC, P.O. BOX 19928, ALEXANDRIA, VA, 22320, US

(21) Appl. No.: 10/493,020

(22) PCT Filed: Oct. 22, 2002
(86) PCT No.: PCT/NL02/00667

(30) Foreign Application Priority Data
Oct. 22, 2001 (NL) 1019204
Jun. 2, 2002 (NL) 1019910

(51) Int. Cl. F16H 55/56; F16H 9/12; F16H 61/00

(52) U.S. Cl. 474/8; 474/20; 474/41

(57) ABSTRACT

A continuously variable transmission comprises a housing (1) which accommodates two pulley sets (2, 3) and an endless flexible drive element (24) fitted around said pulley sets for transferring a torque, one of said pulley sets being provided with coupling means (14) for an ingoing shaft and the other with coupling means (22) for an outgoing shaft, said pulley sets each comprising two discs (4, 5) enclosing a groove which increases in radially outward direction, and screw drive means (6) for changing the distance between the two discs of each pulley set with the aim of changing the transmission ratio. Each disc is connected to a hub unit (7, 8) comprising a rolling element bearing means (9, 10, 30) for rotatably supporting the disc, each hub unit being axially displaceably supported with respect to the housing.

The invention is related to a continuously variable transmission, comprising a housing which accommodates two pulley sets and an endless flexible element fitted around said pulley sets for transferring a torque, one of said pulley sets being provided with coupling means for an ingoing shaft and the other with coupling means for an outgoing shaft, said pulley sets each comprising two discs enclosing a groove which increases in radially outward direction and screw drive means for changing the distance between the two discs of each pulley set with the aim of changing the transmission ratio.

Such a continuously variable transmission is generally known. The pulley sets are accommodated on an ingoing shaft, respectively an outgoing shaft, which shafts are rotatably supported with respect to the housing through rolling element bearings. Usually, one of the discs of each pulley set is slidable with respect to the corresponding shaft through a key/groove connection, or a ball/raceway connection.

The pulleys are therefore indirectly supported with respect to the housing, that is through the shafts. The object of the invention is to provide a continuously variable transmission in which the support of the pulleys is improved and manufacturing costs are reduced. This object is achieved in that each disc is connected-to a hub unit comprising a rolling element bearing means for supporting the disc rotatably as well as axially displaceably with respect to the housing.

In the continuously variable transmission according to the invention, the pulley sets are directly supported with respect to the housing through their hubs. Said hubs in turn can be supported with respect to the housing by means of a plain bearing or ball/raceway or key/groove connection. Thus, the discs can freely carry out axial movements upon changing the transmission ratio. The pulley sets for the drive shaft and the driven shaft can have a high degree of uniformity having regard to the fact that the discs thereof move simultaneously from each other and towards each other.

The hub units should be able to support the discs under loading conditions in a stable fashion. To that end, each hub unit may comprise a double row angular contact bearing. Preferably, each hub unit comprises a sleeve or outer ring within which the rolling element bearing means is fixed, and the housing comprises corresponding cylinder parts in each of which a sleeve is slidably accommodated through a sliding/axial moveable bearing.

According to a second embodiment, at least one bearing means may comprise a rolling element bearing having an inner ring and an outer ring the raceways of which are in rolling contact with a series of rolling elements, said contacts between the rolling elements and at least one of the rings allowing axial displacements. The axial displacements of the bearing rings may be obtained in several ways. According to a first possibility, the rings of at least one rolling element bearing can have a cylindrical raceway, and the rolling elements can have a cylindrical shape. In that case, one of the rings of the rolling element bearing may have shoulders which enclose the cylindrical raceway, the rolling elements being accommodated with slight play between the shoulders, the width of the raceway of the other ring being larger than the distance between said shoulders. In view of the moment loading on the discs of the pulley sets it may be necessary to provide a special crowning or curvature on the rollers and raceways; as an example, the so-called CARBS® bearing may be applied.

A solid, simple layout is obtained in case each hub unit comprises an inner ring member, which is integral with the corresponding pulley.

With the aim of accommodating the axial movements of the pulley hub units, each coupling means comprises a telescoping end for engaging a corresponding telescoping end of an ingoing shaft or an outgoing shaft.

The linear moving screw drive means of each pulley set comprise a central screw shaft with opposite screw thread parts, each disc or pulley hub unit being provided with a nut which engages one of said screw thread parts. The nut of the ball screw and the inner ring of the support bearing can be made of one piece.

The invention will now be described further with reference to several embodiments of the continuously variable transmission shown in the drawings.

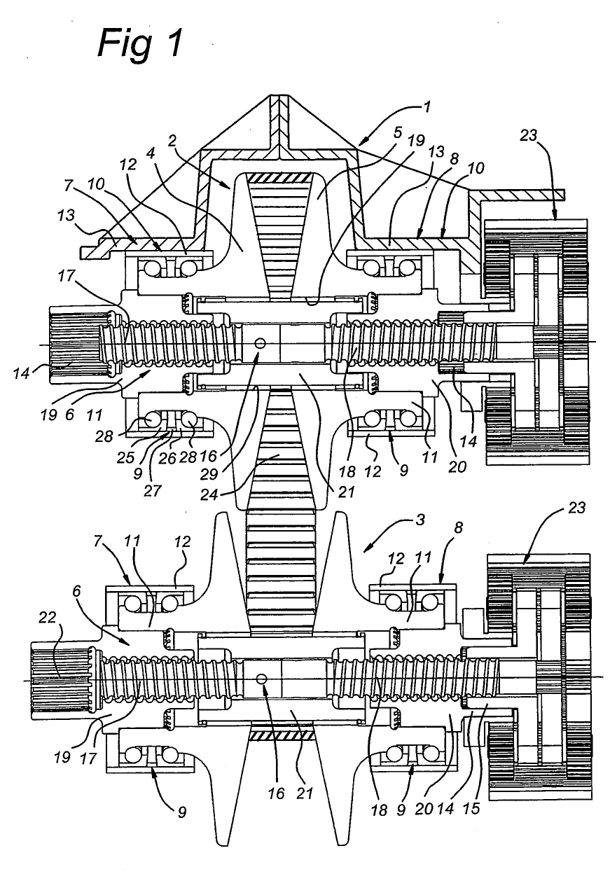

FIG. 1 shows a first embodiment of the continuously variable transmission according to the invention.

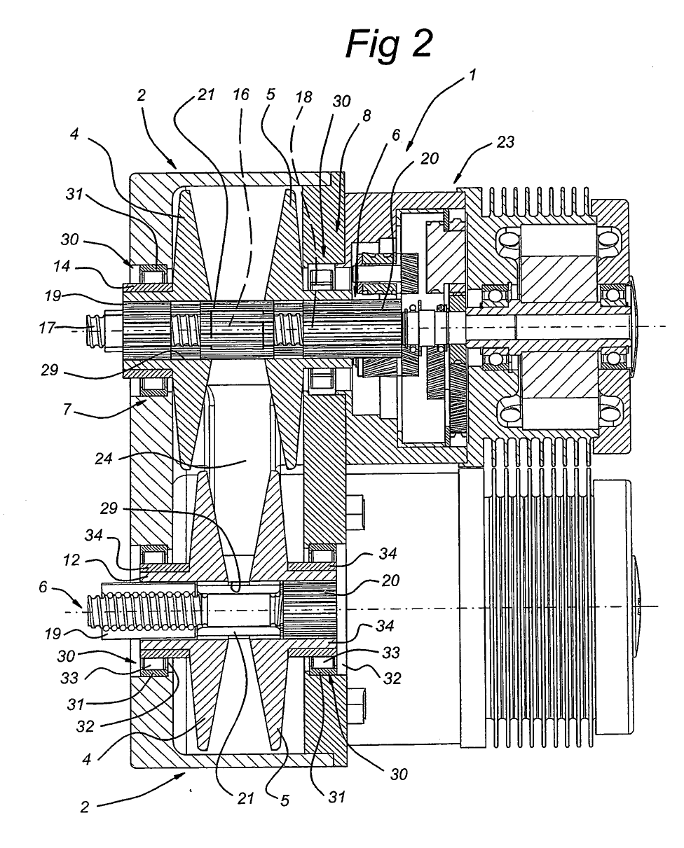

FIG. 2 shows a second embodiment.

The continuously variable transmission shown in FIG. 1 comprises a housing 1 which accommodates two pulley sets 2, 3. The pulley sets 2, 3 each contain two discs 4, 5 which enclose a V-shaped groove. A belt or other endless flexible element 24 (push or pull) is accommodated in the grooves between the discs 4, 5 of the two pulley sets 2, 3.

The discs 4, 5 of the pulley sets 2, 3 can be moved towards and from each other so as to change the transmission ratio between the pulley sets 2, 3. The discs 4, 5 are to that end supported each by respective pulley hub units 7, 8. These pulley hub units 7, 8 are axially displaceably supported with respect to the housing 1 by means of e.g. plain bearings 10. These plain bearings each comprise a sleeve 12 which slideably fits in the correspondingly shaped cylinder part 13 of the housing 1.

Furthermore, the pulley hub units 7, 8 each comprise a double row angular contact bearing 9, which are greased and sealed for life. By means of this double row angular contact bearing 9, the discs 4, 5 in question are rotatably supported with respect to the housing 1 in a very stable fashion.

The double row angular contact bearings 9 each consists of a common inner ring member 11 which is integral with the corresponding disc 4, 5. Also a separate inner ring can be applied. Furthermore two separate outer rings 25, 26 are provided, which are supported with respect to each other in axial direction by means of a spacer ring 27. Also a one piece outer ring can be applied. Between the races of the inner ring member 11 and the outer rings 25, 26, two series of balls 28 are accommodated.

As mentioned, the discs 4, 5 are stably supported with respect to the housing by means of the hub units 7, 8. Additionally however, a further support in the form of a hollow central shaft 21 is applied which slideably fits within the bore 29 of each disc 4, 5 and hub unit 7, 8. The hollow central shaft 21 may engage these elements through an axial key/groove connection or a ball/raceway connection. Under ideal running conditions (no slip) this hollow central shaft is not necessary.

The discs 4, 5 are axially movable with respect to each other through the screw drive means 6 which comprises a central screw shaft 16 with opposite screw thread parts 17, 18. Furthermore, each disc, 5 or hub unit 7, 8 carries a nut 19, 20 which engages one of the screw thread parts 17, 18.

The central screw shaft 16 is connected to a mechanical control means which provides a relative rotation between said central screw shaft 16 and the corresponding pulley set 2, 3.

The pulley sets 2, 3, in particular the nuts 19, 20 thereof, are each provided with coupling means 14, 22 for connection to a drive/driven shaft. This coupling means is constituted by a telescoping end and has grooves which axially displaceably can engage a correspondingly shaped end of said drive/driven shafts.

The embodiment shown in FIG. 2 is, to a large extent, similar to the embodiment according to FIG. 2. Corresponding parts have been identified therein with the same reference numerals.

The hub units 7, 8 of the continuously variable transmission according to FIG. 2 each comprise roller bearings 30, the fixed outer ring 31 of which is connected to the housing 1. The fixed outer ring 31 has shoulders 32, between which the series of rollers 33 are accommodated with slight axial play.

The inner ring 34 is clamped on the hub units 7, 8, and mechanically walk in axial direction with a mechanical means such as a circlip or by material upsetting using cold forming or orbital forming. The inner ring 34 can as an alternative also be formed in one piece with the hub. The raceway of said ring 34 has a width which is larger than the distance between the shoulders 32 of the outer rings 31.

The discs 4, 5, supported by the hub units 7, 8 may now be moved out of each other and towards each other due to the fact that the rollers 33 are not only in rolling contact with the inner rings 34, but also in sliding contact. Under running conditions, this axial sliding movement can take place in a very smooth way.

Although the hub unit comprises a single row bearing, also one or more separate bearings may be applied. The bearings may include ball and roller bearings, e.g. taper roller, needle bearings or spherical by shaped roller bearings. The belt 24 can be cooled by lubricant or with a special liquid or with air.

Furthermore, the pulley hub units and also the continuously variable transmission as a whole contains sensors for controlling and monitoring load, number of revolutions, temperature, etc. The pulley hub units can be self contained, greased and sealed for life.

The discs have a V-shaped groove with a minimum width of 15 mm. The enclosed angle of the V-shape varies between 5 to 30 degrees. The surface contacts of the hub and the flexible belt can be straight, curved or a combination thereof.

One or both pulley sets can be equipped with springs to position or preload the flexible drive means. The components of the pulley hub unit can be made of metallic or non-metallic material, composite material, powder material, etc. Furthermore, the facing surfaces of the disc may have a coating to improve the frictional characteristics for improving torque transfer. The discs may be cold formed and/or hard turned or whirled for providing optimal frictional characteristics for torque transfer as well. The discs can be made of cast iron with a hardened surface, e.g. obtained by laser cladding to obtain the required wear resistant and frictional characteristics for torque transfer.

The inner ring of the pulley hub unit may form a unity with the nut of screw device. Furthermore, the pulley hub unit may have a double row angular contact bearing, one raceway of which is integrated in the hub and the other of which is a separate ring locked by cold forming or mechanical locking device onto the hub.

1. Continuously variable transmission, comprising a housings which accommodates two pulley sets and an endless flexible drive element fitted around said pulley sets for transferring a torque, one of said pulley sets being provided with coupling means for an ingoing shaft and the other with coupling means for an outgoing shaft, said pulley sets each comprising two discs enclosing a groove which increases in radially outward direction, and screw drive means for changing the distance between the two discs of each pulley set with the aim of changing the transmission ratio, each disc being connected to a hub unit comprising bearing means supporting the disc rotatably with respect to the housing, characterized in that said hub unit also comprised bearing means supporting the disc axially displaceably with respect to the housing.

2. Transmission according to claim 1, wherein each hub unit is supported with respect to the housing by means of a linear bearing e.g. a plain bearing or a ball/raceway bearing.

3. Transmission according to claim 2, wherein each hub unit comprises an outer ring or sleeve within which the rolling element bearing means is fixed, and the housing comprises corresponding cylinder parts in each of which a sleeve is slidably accommodated through the plain bearing.

4. Transmission according to claim 1, wherein each hub unit comprises a double row angular contact bearing.

5. Transmission according to claim 1, wherein at least one rolling element bearing means comprises a 4-point angular contact ball bearing.

6. Transmission unit according to claim 1, wherein at least one rolling element bearing means comprises an asymmetric angular contact bearing.

7. Transmission according to claim 1, wherein each bearing means comprises a rolling element bearing having an inner ring and an outer ring the raceways of which are in rolling contact with a series of rolling elements said contacts between the rolling elements e and at least one of the rings allowing axial displacements.

8. Transmission according to claim 7, wherein the rings of at least one rolling element bearing have a cylindrical raceway, and the rolling elements have a cylindrical shape.

9. Transmission according to claim 7, wherein the rings of at least one rolling element bearings have a crowned raceway, and the rolling elements have a crowned shape.

10. Transmission according to claim 8, wherein one of the rings has shoulders which enclose the cylindrical raceway, the rolling elements being accommodated with slight play between the shoulders the width of the raceway of the other ring being larger than the distance between said shoulders.

11. Transmission according to claim 1, wherein each coupling means comprises a telescoping member for engaging a corresponding telescoping end of an ingoing shaft or an outgoing shaft.

12. Transmission according to claim 1, wherein the screw drive means of each pulley set comprise a central screw shaft with opposite screw thread parts each disc or hub unit being provided with a nut which engages one of said screw thread parts.

13. Transmission according to claim 12, wherein each screw shaft is connected to a mechanical control means and or electrical/electronic control means.

14. Transmission according to claim 1, wherein the discs are each slidably accommodated on a hollow central shaft.

15. Transmission according to claim 1, wherein at least one rolling element bearing means comprises an asymmetric angular contact ball bearing.

16. Transmission according to claim 1, wherein at least one screw actuator is a roller screw actuator.

17. Transmission according to claim 1, wherein at least one screw actuator is a ball screw actuator.

18. Transmission according to claim 1, wherein at least one screw actuator is a friction screw actuator.

19. Transmission according to claim 1, wherein the nuts of the screw actuators are accommodated on a common drive shaft extending through the pulley sets.

20. Transmission according to claim 1, wherein the nuts are provided with drive means, e.g. splines for connection to the drive clutch, control unit and differential.

21. Transmission according to claim 13 wherein the control means comprises an electrical, electronic, hydraulic device or a combination of these.

22. Transmission according to claim 1, wherein a sensor is provided for sensing a parameter associated with the rotational movement of the drive shaft, load, temperature etc.

23. Transmission according to claim 1, wherein a sensor is provided for sensing a parameter associated with the rotational movement of the drive shaft and/or driven shaft.

24. Transmission according to claim 1, wherein the pulley sets are mutually connected by splined bushing.

25. Transmission according to claim 1, wherein the flexible element is a pull chain or push belt, e.g. a flexible metallic belt, non metallic belt, composite belt or combination of these.

26. Transmission according to claim 1, wherein the flexible element is a chain, belt (push or pull).

27. Transmission according to claim 1, wherein the discs of each one pulley set are identical.

28. Transmission according to claim 1, wherein at least one of the pulley sets comprises a sensor for sensing a parameter associated with the rotational movement of the drive shaft, load, temperature etc.
